(19) United States
(12) Patent Application Publication
(10) Pub. No.: US 2005/0233762 A1
(43) Pub. Date: Oct. 20, 2005

(54) Cellular phone terminal and control method of cellular phone terminal

(75) Inventor: Kazuhito Shimomura, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 10/986,119

(22) Filed: Nov. 12, 2004

(30) Foreign Application Priority Data
Apr. 20, 2004 (JP) JP2004-124585

(51) Int. Cl. H04M 1/00

(52) U.S. Cl. 455/550.1

(57) ABSTRACT

Disclosed is a cellular phone terminal including: a processing part including a transmitting/receiving part; a hard disc drive capable of holding information processable by the processing part and information having been processed by the processing part; a hard disc drive control part interposed between and connected to the processing part and the hard disc drive and controlling transfer of information from the processing part to the hard disc drive and transfer of information from the hard disc drive to the processing part; and a recording preventing part provided in the hard disc drive control part and preventing information to be transferred from the processing part to the hard disc drive from being recorded on the hard disc drive.

### CROSS-REFERENCE TO RELATED APPLICATIONS

This application is based upon and claims the benefit of priority from the prior Japanese Patent Application No. 2004-124585, filed on Apr. 20, 2004; the entire contents of which are incorporated herein by reference.

### BACKGROUND

1. Field of the Invention

The present invention relates to a cellular phone terminal that is portably used and a control method of the same, and more particularly, to a cellular phone terminal having a built-in hard disc drive as a storage part and a control method of the same.

2. Description of the Related Art

In the field of cellular phone terminals, cellular phone terminals are coming to have functions other than a call function and thus are becoming more multifunctional. A function as a browser phone by data communication has already been very common, and accordingly, volume of dealt information, for example, audio and images is continuously increasing. Therefore, a storage memory capacity demanded for cellular phones naturally has to become larger.

Generally, a user can freely write and read to/from a memory as far as its capacity permits, but it is sometimes preferable to provide some kind of restriction. The following patent document 1 describes an art, though it is a device somewhat different from a cellular phone terminal, for providing such a restriction. In this device, a flag that prohibits write to a memory module is set in response to power-off of a main body. In this manner, it is prevented that data is written carelessly to erase original data when the power source is turned on again.
[Patent document 1] Japanese Patent Application Publication No. Hei 3-15212

In order to provide a large capacity memory in a cellular phone terminal, it is advantageous under the current circumstances to mount a built-in small hard disc drive, in view of portability of the terminal. It is thought that a restriction on information write is sometimes required also when such a hard disc drive is mounted in a terminal.

### SUMMARY

The present invention was devised in view of the above-described circumstances, and it is an object of the present invention to provide a cellular phone terminal that is portably used and a control method of the same, and more particularly, to a cellular phone terminal and a control method of the same capable of providing, as a terminal, a restriction on write to a built-in hard disc drive.

A cellular phone terminal according to an aspect of the present invention includes: a processing part including a transmitting/receiving part; a hard disc drive capable of holding information processable by the processing part and information having been processed by the processing part; a hard disc drive control part interposed between and connected to the processing part and the hard disc drive and controlling transfer of information from the processing part to the hard disc drive and transfer of information from the hard disc drive to the processing part; and a recording preventing part provided in the hard disc drive control part and preventing information to be transferred from the processing part to the hard disc drive from being recorded on the hard disc drive.

Therefore, the recording preventing part is disposed in the hard disc drive control part that is interposed between the processing part, which includes the transmitting/receiving part, and the hard disc drive. The recording preventing part prevents the information to be transferred from the processing part to the hard disc drive from being recorded on the hard disc drive. “The information to be transferred from the processing part to the hard disc drive” is information that is originally intended to be recorded on the hard disc drive, but the recording preventing part functions to prevent this information from being recorded. This means that a restriction on write to the built-in hard disc drive can be provided as a terminal.

According to another aspect of the present invention, provided is a control method of a cellular phone terminal that includes: a processing part including a transmitting/receiving part; a hard disc drive capable of holding information processable by the processing part and information having been processed by the processing part; a hard disc drive control part interposed between and connected to the processing part and the hard disc drive and controlling transfer of information from the processing part to the hard disc drive and transfer of information from the hard disc drive to the processing part, the method comprising: issuing by the hard disc drive control part a recording command to the hard disc drive when transferring the information from the processing part to the hard disc drive; confirming, prior to the issue of the recording command, by the hard disc drive control part whether or not a recording command issue prohibiting flag is set; and canceling, by the hard disc drive control part, the issue of the recording command when the recording command issue prohibiting flag is set.

Therefore, in this control method, prior to the issue of the recording command, which is conducted when information is recorded on the hard disc drive, it is confirmed whether or not the recording command issue prohibiting flag is set. If the recording command issue prohibiting flag is set, the issue of the recording command is cancelled. When the recording command issue prohibiting flag is set, the information is not recorded since the issue of the recording command is cancelled. Therefore, a restriction on write to a built-in hard disc drive can be provided as a terminal.

Another cellular phone terminal according to an aspect of the present invention includes: a processing part including a transmitting/receiving part; a hard disc drive capable of holding information processable by the processing part and information having been processed by the processing part; a hard disc drive control part interposed between and connected to the processing part and the hard disc drive and controlling transfer of information from the processing part to the hard disc drive and transfer of information from the hard disc drive to the processing part, the hard disc drive control part issuing a recording command to the hard disc drive when transferring the information from the processing part to the hard disc drive; and a recording command issue prohibiting flag holding part provided in the hard disc drive control part, capable of recording information indicating that the issue of the recording command by the hard disc drive control part should be prohibited, and prior to the issue of the recording command by the hard disc drive control part, supplying the hard disc drive control part with the information indicating that the issue of the recording command should be prohibited.

This terminal has the recording command issue prohibiting flag holding part so that the above-described control method is usable.

According to the present invention, it is possible to provide, as a terminal, a restriction on write to a built-in hard disc drive in a cellular phone terminal that is portably used and in a control method of the same.

### BRIEF DESCRIPTION OF THE DRAWINGS

FIG. 1 is a block diagram showing the configuration of a cellular phone terminal according to an embodiment of the present invention.

FIG. 2 is a block diagram showing the configuration of a cellular phone terminal according to another embodiment of the present invention.

FIG. 3 is a flowchart showing an operation of a HDD control part 30 in the cellular phone terminal shown in FIG. 2 when it detects a recording prevention input.

FIG. 4 is a flowchart showing an operation of the HDD control part 30 of the cellular phone terminal shown in FIG. 2 at the time of contract cancellation.

FIG. 5 is a flowchart showing an operation of the HDD control part 30 after the recording prevention is set in the cellular phone terminal shown in FIG. 2.

### DETAILED DESCRIPTION

### Description of Embodiments

Embodiments of the present invention will be described with reference to the drawings, but these drawings are provided only for an illustrative purpose and are in no respect intended to limit the present invention.

As a form of an embodiment of the present invention, the hard disc drive can include: a recording head; a head unsafe detecting part detecting soundness of the recording head; and a local control part which switches between recording/nonrecordinq of information from the processing part based on a result of the detection by the head unsafe detecting part, and the recording preventing part can use the local control part of the hard disc drive in order to prevent the information to be transferred from the processing part to the hard disc drive from being recorded on the hard disc drive. The local control part of the hard disc drive works so as prevent the information from being recorded even in a recording mode when a head unsafe condition is detected. Therefore, the recording preventing part utilizes this function to prevent information from being recorded.

As another form, the cellular phone terminal can further include a contract information holding part capable of holding information indicating contract cancellation of the cellular phone terminal and/or information indicating that the cellular phone terminal is under contract, and the recording preventing part can prevent the information to be transferred from the processing part to the hard disc drive from being recorded on the hard disc drive based on contents of the contract information holding part. It is thought that a necessary access to the hard disc drive differs depending on whether or not the cellular phone terminal is under contract. Therefore, the information on whether or not the cellular phone terminal is under contract is obtained from the contract information holding part and based on this information, the recording preventing part prevents the information from being recorded on the hard disc drive.

As still another form, the recording preventing part can prevent the information to be transferred from the processing part to the hard disc drive from being recorded on the hard disc drive in response to inputting of a recording prevention instruction to the hard disc drive control part. This design is intended for a case where the instruction of recording prevention is intentionally inputted from an external part.

As yet another form, the processing part can include an image pickup part and an image display part, and the hard disc drive can be designed to be capable of holding image information picked up by the image pickup part of the processing part and image information to be displayed on the image display part of the processing part. This design is intended for a case of a so-called cellular phone with camera. Image information is also a kind of information processable by the processing part.

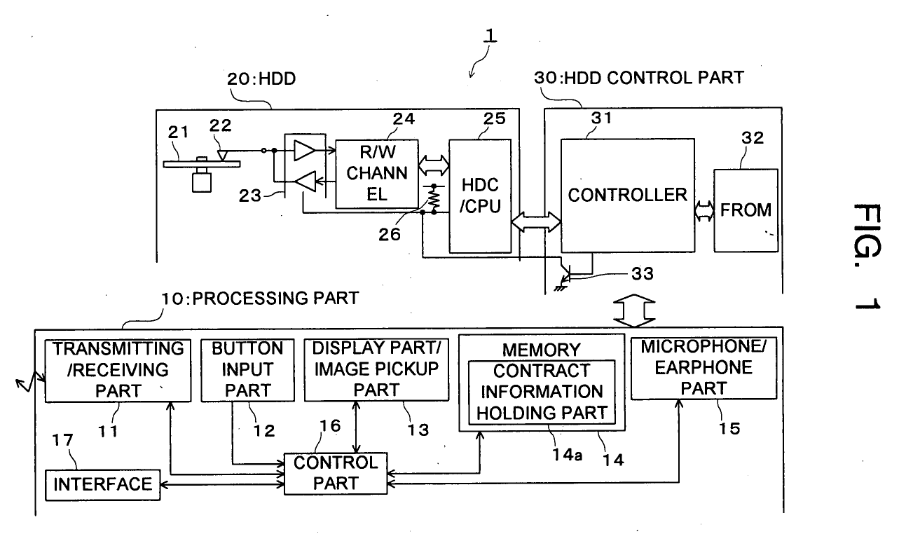

Based on the foregoing, embodiments of the present invention will be hereinafter described with reference to the drawings. FIG. 1 is a block diagram showing the configuration of a cellular phone terminal according to an embodiment of the present invention. As shown in FIG. 1, the cellular phone terminal 1 has a processing part 10, a hard disc drive (hereinafter, abbreviated to HDD) 20, and a HDD control part 30.

The processing part 10 is a main body portion of the cellular phone terminal 1 excluding a mass-memory unit, and it has a transmitting/receiving part 11, a button input part 12, a display part/image pickup part 13, a memory 14 including a contract information holding part 14a, a microphone/earphone part 15, a control part 16, and an interface 17. The HDD 20 functions as the mass-memory unit of the cellular phone terminal 1 and it has a hard disc 21, a recording/reproducing head 22, a recording/reproducing amplifier 23, a R/W channel (read/write channel) 24, a HDC/CPU (hard disc controller/central processing unit). 25, and a pullup resistor 26. The HDD control part 30 is interposed between and connected to the processing part 10 and the HDD 20, and it controls the transfer of information from the processing part 10 to the HDD 20 and the transfer of information from the HDD 20 to the processing part 10. The HDD control part 30 has a controller 31, a FROM (flash ROM (read only memory)) 32, and a transistor switch 33.

It is one of the structural characteristics of the cellular phone terminal 1 that the HDD control part 30 has the transistor switch 33. The transistor switch 33 is connected to the controller 31 at its base, to the ground at its emitter, and to a specific input terminal (to be described later) of the HDC/CPU 25 in the HDD 20 at its collector. The transistor switch 33 functions as a recording preventing part.

Functions of the respective parts will be described below. First, as for the processing part 10, the transmitting/receiving part 11 includes an antenna. Under control of the control part 16, the transmitting/receiving part 11 modulates a predetermined radio wave by information to be transmitted such as audio, data, or an image to radiate the modulated radio wave, and it also obtains such information to be received by receiving and demodulating a radiated radio wave. The button input part 12 is a man-machine interface through which a user inputs an operation to the cellular phone terminal 1. The operation input is received by the control part 16 to be sent to each part.

Under control of the control part 16, the display part/image pickup part 13 displays, as a display part, various kinds of information. The display part/image pickup part 13 also includes a camera as an image pickup part and it converts, under control of the control part 16, an optically inputted image to an electric signal. Information (image information) obtained from an image captured by the display part/image pickup part 13 is recordable on the hard disc 21 of the HDD 20 via the control part 16 and the HDD control part 30. Further, image information recorded on the hard disk 21 is displayable on the display part/image pickup part 13 via the HDD control part 30 and the control part 16.

The memory 14 is a storage area that holds information necessary for the operation of the entire processing part 10. When necessary, the stored contents are referred to by the control part 16 or are sent to the HDD control part 30. Further, information to be stored is inputted to the memory 14 via the control part 16 from the transmitting/receiving part 11, the button input part 12, the display part/image pickup part 13, the microphone/earphone part 15, the interface 17, the HDD control part 30, and so on. The microphone/earphone part 15 includes, as a telephone function, a microphone for speech and a speaker for reception. The control part 16 centrally controls the entire processing part 10 and it includes a CPU. The interface 17 includes a connecter and works as a connecting part for wired exchange of various kinds of data.

As for the HDD 20, the hard disc 21 is a recording medium in a disc shape storing a large volume of information as magnetic patterns arranged in a circumferential direction. The information stored in the hard disc 21 can be various kinds of information, for example, character information, audio information, image information, and so on. The transmitting/receiving part 11, the button input part 12, the display part/image pickup part 13, the transmitter/receiving part 15, and the interface 17 are input ports of the information to be stored. The information inputted from each of these input ports is processed in each part and is recordable on the hard disc 21 of the HDD 20. Further, information recorded on the hard disc 20 can be read out to be sent to each part of the processing part 10 via the HDD control part 30.

The recording/reproducing head 22 is composed of a recording head being an electromagnetic converting element for writing information to the hard disc 21 and a reproducing head being magnetoelectric converting element for reading information from the hard disc 21. The recording/reproducing amplifier 23 has a recording amplifier that generates a recording current to be supplied to the recording head and a reproducing amplifier that amplifies a reproduced electric signal sent from the reproducing head. Further, the recording/reproducing head 22 has a head unsafe detecting part (not shown) that detects soundness of the recording head in terms of the connection therewith. The head unsafe detecting part checks, for example, the frequency of the recording current or the relation between the voltage and the recording current, thereby detecting whether or not the recording head is broken. The detection result is generated as a head unsafe signal, which is pulled up by the pullup resistor 26 to be inputted to a predetermined input terminal of the HDC/CPU 25 as shown in the drawing.

In order to record data to be recorded, which is inputted from the HDC/CPU 25, on the hard disc 21, the R/W channel 24 modulates the data to be recorded, and it also subjects reproduced data, which is inputted from the recording/reproducing head 23, to processing such as demodulation. The HDC/CPU 25 follows a command from the controller 31 of the HDD control part 30 to perform local control of the entire HDD 20. This control includes control over incoming and outgoing of data to be recorded and reproduced data to/from the HDD 20. Here, when the head unsafe signal inputted to the HDC/CPU 25 as described above is at low level, some abnormality is occurring in the recording head, and therefore, the HDC/CPU 25 performs control so as to prohibit recording irrespective of the command from the controller 31 in order to maintain reliability.

As for the HDD control part 30, the controller 31 issues a command for recording or reproducing to the HDD 20 to control the recording or reproducing operation of the HDD 20. This control is executed according to software that is held in the FROM 32 in a nonvolatile state. The FROM 32 is a storage area that holds software and data necessary for the control operation executed by the controller 31. The transistor switch 33 is turned on when the input from the controller 31 is at high level as described above, and the transistor switch 33 is in a connection state so as to be capable of setting an output of the above-described head unsafe signal to low level at this time.

In the cellular phone terminal 1 as structured above, it is possible to intentionally set prevention of recording on the hard disc 21. For example, if the controller 31 is designed such that its output to the transistor 33 follows the contents of a specific storage area of the FROM 32, the state in which recoding is intentionally prevented is realized by rewriting the contents. The contents can be rewritten by, for example, inputting an instruction to that effect from the interface 17 and sending this instruction via the control part 16 and the controller 31 of the HDD control part 30. Alternatively, the transmitting/receiving part 11 may be used for inputting or the button input part 12 may be used for inputting.

Further, it is possible to automatically set recording prevention depending on whether or not the cellular phone terminal 1 is under contract as a terminal. For example, if the cellular phone terminal 1 is under contract, unlimited recording and reproducing are allowed as far as the capacity of the HDD 20 permits. On the other hand, the cellular phone terminal 1, if not under contract, is regarded as having no information to be recorded any more and thus is put in a recording prevention state. This state is realized in such a manner that, for example, the contents of the aforesaid specific storage area in the FROM 32 is designed to be rewritten according to the contents of the contract information holding part 14a in the memory 14, and the controller 31 is designed to follow the contents of the specific storage area in the FROM 32 similarly to the above. In this case, the contract information holding part 14a may hold information indicating contract cancellation, may hold information indicating contract continuation, or may hold both pieces of the information.

Further, also conceivable is a structure such that the input of the transistor switch 33 as the recording preventing part is not connected to the controller 31. In this case, an input voltage to directly turn on the transistor switch 33 is applied to the base of the transistor switch 33 for realizing the state of recording prevention.

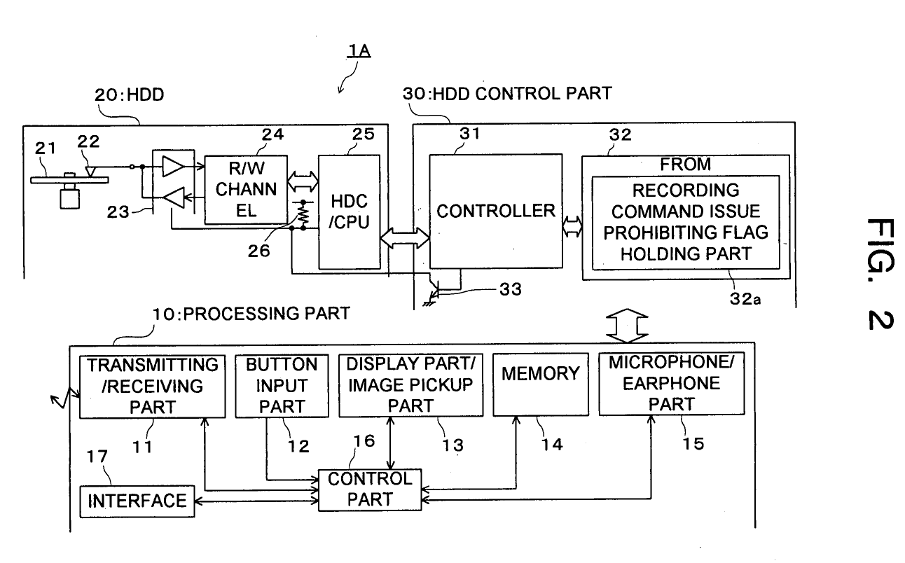

Next, a cellular phone terminal according to another embodiment of the present invention will be described with reference to FIG. 2 to FIG. 5. First, FIG. 2 is a block diagram showing the configuration of a cellular phone terminal 1A according to the other embodiment of the present invention. In FIG. 2, the same reference numerals and symbols are used to designate the same constituent elements as those shown in FIG. 1. Description on these constituent elements will not be given unless there is any particular item to be added.

As shown in the drawing, this embodiment does not include the transistor switch 33 as the recording preventing part, but a FROM 32 has a recording command issue prohibiting flag holding part 32a instead. This is a structure in which recording on a hard disc 21 is prevented not by the transistor switch 33 but by software.

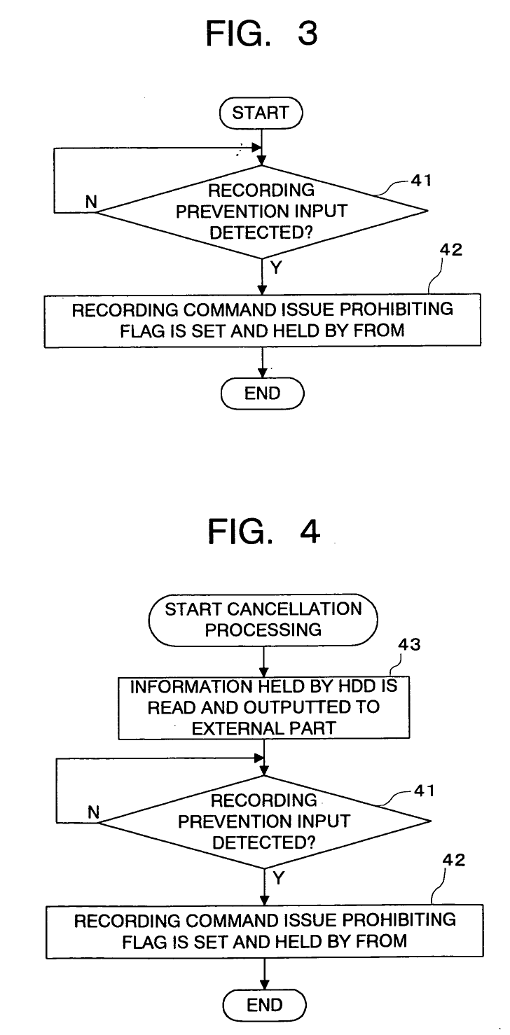

FIG. 3 is a flowchart showing an operation of a HDD control part 30 in the cellular phone terminal shown in FIG. 2 when it detects a recording prevention input. In other words, it is a flow when the cellular phone terminal 1A is put into a state of recording prevention. The HDD control part 30 is normally in a state of being capable of detecting the recording prevention input (Step 41). A transmitting/receiving part 11, a button input part 12, a display part/image pickup part 13, a microphone/earphone part 15, and an interface 17 are input ports to which information instructing the recording prevention is inputted. When the information is inputted from these input ports, a controller 31 of the HDD control part 30 controls; the recording command issue prohibiting flag holding part 32a in the FROM 32 to hold a prohibiting flag (Step 42).

FIG. 4 is a flowchart showing an operation of the HDD control part 30 of the cellular phone terminal shown in FIG. 2 at the time of contract cancellation. In other words, it is a flow when the cellular phone terminal 1A is automatically or intentionally put into the state of recording prevention depending on whether or not the cellular phone terminal 1A is under contract as a terminal. First, in accordance with contract cancellation, information held in a HDD 20 is read to be outputted to an external part (Step 43). This is intended for, for example, transferring the information to a cellular phone terminal that will be used under new contract so that the new cellular phone terminal holds the information.

Next, the HDD control part 30 is put into the state of being capable of detecting the recording prevention input (Step 41). The transmitting/receiving part 11, the button input part 12, the display part/image pickup part 13, the microphone/earphone part 15, and the interface 17 are input ports to which information indicating the recording prevention is inputted. When the information is inputted from these input ports, the controller 31 of the HDD control part 30 controls the recording command issue prohibiting flag holding part 32a in the FROM 32 to hold the prohibiting flag (Step 42). Alternatively, if the contents of a memory 14 are rewritten in accordance with contract cancellation as described in FIG. 1, the recording command issue prohibiting flag holding part 32a in the FROM 32 may be made to hold the prohibiting flag in response to this rewriting or according to the rewritten contents.

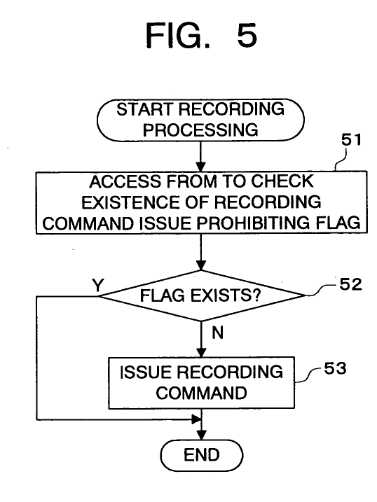

FIG. 5 is a flowchart showing an operation (recording operation) of the HDD control part 30 after the recording prevention is set in the cellular phone terminal shown in FIG. 2. When the HDD control part 30 is put into the state of issuing a recording command, the controller 31 first accesses the recording command issue prohibiting flag holding part 32a of the FROM 32 (Step 51). If the recording command issue prohibiting flag is not set in the recording command issue prohibiting flag holding part 32a (N at Step 52), the recording command is issued (Step 53). This causes the HDD 20 to perform a normal recording operation. If, on the other hand, the recording command issue prohibiting flag is set in the recording command issue prohibiting flag holding part 32a, the recording command is not issued (i.e., is cancelled) and the control returns to the initial step.

As described above, in the embodiment shown in FIG. 2, any additional constituent element such as the transistor switch 33 is not required for shifting the state of a cellular phone terminal to the recording prevention state.

Incidentally, in the foregoing description, a restriction on write to a built-in hard disc drive is provided as a terminal. However, based on the same idea, a usage restriction can be set, for example; camera function termination can be set in response to cancellation information in a case of a cellular phone with camera, TV reception prohibition can be set in a case of a cellular phone with TV tuner, FM reception prohibition can be set in a case of a cellular phone with FM tuner, and so on.

It should be noted that the present invention is not limited to the specific embodiments described here with reference to the drawings, but it is understood that all modifications which come within the range of the following claims are included in the present invention.

1. A cellular phone terminal, comprising:
a processing part including a transmitting/receiving part;
a hard disc drive capable of holding information processable by the processing part and information having been processed by the processing part;
a hard disc drive control part interposed between and connected to the processing part and the hard disc drive and controlling transfer of information from the processing part to the hard disc drive and transfer of information from the hard disc drive to the processing part; and
a recording preventing part provided in the hard disc drive control part and preventing information to be transferred from the processing part to the hard disc drive from being recorded on the hard disc drive.

2. A cellular phone terminal as set forth in claim 1,
wherein the hard disc drive includes: a recording head; a head unsafe detecting part detecting soundness of the recording head; and a local control part which switches between recording/nonrecording of information from the processing part based on a result of the detection by the head unsafe detecting part, and
wherein the recording preventing part uses the local control part of the hard disc drive in order to prevent the information to be transferred from the processing part to the hard disc drive from being recorded on the hard disc drive.

3. A cellular phone terminal as set forth in claim 1, further comprising:
a contract information holding part capable of holding information indicating contract cancellation of the cellular phone terminal and/or information indicating that the cellular phone terminal is under contract,
wherein the recording preventing part prevents the information to be transferred from the processing part to the hard disc drive from being recorded on the hard disc drive based on contents of the contract information holding part.

4. A cellular phone terminal as set forth in claim 1,
wherein the recording preventing part prevents the information to be transferred from the processing part to the hard disc drive from being recorded on the hard disc drive in response to inputting of a recording prevention instruction to the hard disc drive control part.

5. A cellular phone terminal as set forth in claim 1,
wherein the processing part includes an image pickup part and an image display part, and
wherein the hard disc drive is capable of holding image information picked up by the image pickup part of the processing part and image information to be displayed on the image display part of the processing part.

6. A control method of a cellular phone terminal that includes: a processing part including a transmitting/receiving part; a hard disc drive capable of holding information processable by the processing part and information having been processed by the processing part; a hard disc drive control part interposed between and connected to the processing part and the hard disc drive and controlling transfer of information from the processing part to the hard disc drive and transfer of information from the hard disc drive to the processing part,
the method, comprising:
issuing by the hard disc drive control part a recording command to the hard disc drive when transferring the information from the processing part to the hard disc drive;
confirming, prior to the issue of the recording command, by the hard disc drive control part whether or not a recording command issue prohibiting flag is set; and
canceling, by the hard disc drive control part, the issue of the recording command when the recording command issue prohibiting flag is set.

7. A cellular phone terminal, comprising:
a processing part including a transmitting/receiving part;
a hard disc drive capable of holding information processable by the processing part and information having been processed by the processing part;
a hard disc drive control part interposed between and connected to the processing part and the hard disc drive and controlling transfer of information from the processing part to the hard disc drive and transfer of information from the hard disc drive to the processing part, the hard disc drive control part issuing a recording command to the hard disc drive when transferring the information from the processing part to the hard disc drive; and
a recording command issue prohibiting flag holding part provided in the hard disc drive control part, capable of recording information indicating that the issue of the recording command by the hard disc drive control part should be prohibited, and prior to the issue of the recording command by the hard disc drive control part, supplying the hard disc drive control part with the information indicating that the issue of the recording command should be prohibited.
